(19) United States
(12) Patent Application Publication
(10) Pub. No.: US 2024/0331700 A1
(43) Pub. Date: Oct. 3, 2024

(54) On-Device Multilingual Speech Recognition

(71) Applicant: Google LLC, Mountain View, CA (US)

(72) Inventors: Yang Yu, Millburn, NJ (US); Quan Wang, Hoboken, NJ (US); Ignacio Lopez Moreno, Brooklyn, NY (US)

(73) Assignee: Google LLC, Mountain View, CA (US)

(21) Appl. No.: 18/191,711

(22) Filed: Mar. 28, 2023

(51) Int. Cl. G10L 15/26; G10L 15/32

(52) U.S. Cl. CPC G10L 15/26; G10L 15/32

(57) ABSTRACT

A method includes receiving a sequence of input audio frames and processing each corresponding input audio frame to determine a language ID event that indicates a predicted language. The method also includes obtaining speech recognition events each including a respective speech recognition result determined by a first language pack. Based on determining that the utterance includes a language switch from the first language to a second language, the method also includes loading a second language pack onto the client device and rewinding the input audio data buffered by an audio buffer to a time of the corresponding input audio frame associated with the language ID event that first indicated the second language as the predicted language. The method also includes emitting a first transcription and processing, using the second language pack loaded onto the client device, the rewound buffered audio data to generate a second transcription.

### TECHNICAL FIELD

This disclosure relates to application programming interfaces for on-device speech services.

### BACKGROUND

Speech service technologies such as automatic speech recognition are being developed for on-device use where speech recognition models trained via machine learning techniques are configured to run entirely on a client device without the need to leverage computing resources in a cloud computing environment. The ability to run speech recognition on-device drastically reduces latency and can further improve the overall user experience by providing “streaming” capability where speech recognition results are emitted in a streaming fashion and can be displayed for output on a screen of the client device in a streaming fashion. Moreover, many users prefer the ability for speech services to provide multilingual speech recognition capabilities so that speech can be recognized in multiple different languages. Creators of speech services may offer these speech services in the public domain for use by application developers who may want to integrate the use of the speech services into the functionality of the applications. For instance, creators may designate their speech services as open-source. In addition to speech recognition, other types of speech services that developers may want to integrate into the functionality of their application may include speaker labeling (e.g., diarization) and/or speaker change events.

### SUMMARY

One aspect of the disclosure provides a computer-implemented method executed on data processing hardware of a client device that causes the data processing hardware to perform operations that include, while a first language pack for use in recognizing speech in a first language is loaded onto the client device, receiving a sequence of input audio frames generated from input audio data characterizing an utterance, and processing, by a language identification (ID) predictor model, each corresponding input audio frame in the sequence of input audio frames to determine a language ID event associated with the corresponding input audio frame that indicates a predicted language for the corresponding input audio frame. The operations also include obtaining a sequence of speech recognition events for the sequence of input audio frames, each speech recognition event including a respective speech recognition result in the first language determined by the first language pack for a corresponding one of the input audio frames. Based on determining that the language ID events are indicative of the utterance including a language switch from the first language to a second language, the operations also include loading, from memory hardware of the client device, a second language pack onto the client device for use in recognizing speech in the second language and rewinding the input audio data buffered by an audio buffer to a time of the corresponding input audio frame associated with the language ID event that first indicated the second language as the predicted language. The operations also include emitting, using the respective speech recognition results determined by the first language pack for only the corresponding input audio frames associated language ID events that indicate the first language as the predicted language, a first transcription for a first portion of the utterance, and processing, using the second language pack loaded onto the client device, the rewound buffered audio data to generate a second transcription for a second portion of the utterance.

Implementations of the disclosure may include one or more of the following optional features. In some implementations, the first transcription includes one or more words in the first language and the second transcription includes one or more words in the second language. In some examples, the language ID event determined by the language ID predictor model that indicates the predicted language for each corresponding input audio frame further includes a probability score indicating a likelihood that the corresponding input audio frame includes the predicted language. In these examples, the operations may also include determining that the probability score of one of the language ID events that indicates the first language as the predicated language satisfies a confidence threshold, wherein determining that the language ID events are indicative of the utterance including the language switch from the first language to the second language is based on the determination that the probability score of the one of the language ID events that indicates the first language as the predicated language satisfies the confidence threshold. Here, the probability score of the language ID event that first indicated the second language as the predicated language may fail to satisfy the confidence threshold. Additionally or alternatively, the corresponding input audio frame associated with the language ID event that first indicated the second language as the predicted language may occur earlier in the sequence of input audio frames than the corresponding input audio frame associated with the one of the language ID events that includes the probability score satisfying the confidence threshold.

In some implementations, the operations further include, based on the determination that the language ID events are indicative of the utterance including the language switch from the first language to the second language, setting a rewind audio buffer pin to the time of the corresponding input audio frame associated with the language ID event that first indicated the second language as the predicted language. Here, rewinding the audio data buffered by the audio buffer includes causing the audio buffer to rewind the buffered audio data responsive to setting the rewind audio buffer pin to the time of the corresponding input audio frame associated with the language ID event that first indicated the second language as the predicted language.

In some examples, each speech recognition event including the respective speech recognition result in the first language further includes an indication that the respective speech recognition result includes a partial result or a final result. In these examples, the operations may further include determining that the indication for the respective speech recognition result of the speech recognition event for the corresponding input audio frame associated with the last language ID event to indicate the first language as the predicted language includes a partial result and setting a forced emit pin to a time of the corresponding input audio frame associated with the last language ID event to indicate the first language as the predicted language, thereby forcing the emitting of the first transcription of the first portion of the utterance. The first language pack and the second language pack may each include at least one of an automated speech recognition (ASR) model, an external language model, neural network types, an acoustic encoder, components of a speech recognition decoder, or the language ID predictor model.

Another aspect of the disclosure provides a system including data processing hardware of a client device and memory hardware in communication with the data processing hardware and storing instructions that when executed on the data processing hardware causes the data processing hardware to perform operations that include, while a first language pack for use in recognizing speech in a first language is loaded onto the client device, receiving a sequence of input audio frames generated from input audio data characterizing an utterance, and processing, by a language identification (ID) predictor model, each corresponding input audio frame in the sequence of input audio frames to determine a language ID event associated with the corresponding input audio frame that indicates a predicted language for the corresponding input audio frame. The operations also include obtaining a sequence of speech recognition events for the sequence of input audio frames, each speech recognition event including a respective speech recognition result in the first language determined by the first language pack for a corresponding one of the input audio frames. Based on determining that the language ID events are indicative of the utterance including a language switch from the first language to a second language, the operations also include loading, from memory hardware of the client device, a second language pack onto the client device for use in recognizing speech in the second language and rewinding the input audio data buffered by an audio buffer to a time of the corresponding input audio frame associated with the language ID event that first indicated the second language as the predicted language. The operations also include emitting, using the respective speech recognition results determined by the first language pack for only the corresponding input audio frames associated language ID events that indicate the first language as the predicted language, a first transcription for a first portion of the utterance, and processing, using the second language pack loaded onto the client device, the rewound buffered audio data to generate a second transcription for a second portion of the utterance

This aspect may include one or more of the following optional features. In some implementations, the first transcription includes one or more words in the first language and the second transcription includes one or more words in the second language. In some examples, the language ID event determined by the language ID predictor model that indicates the predicted language for each corresponding input audio frame further includes a probability score indicating a likelihood that the corresponding input audio frame includes the predicted language. In these examples, the operations may also include determining that the probability score of one of the language ID events that indicates the first language as the predicated language satisfies a confidence threshold, wherein determining that the language ID events are indicative of the utterance including the language switch from the first language to the second language is based on the determination that the probability score of the one of the language ID events that indicates the first language as the predicated language satisfies the confidence threshold. Here, the probability score of the language ID event that first indicated the second language as the predicated language may fail to satisfy the confidence threshold. Additionally or alternatively, the corresponding input audio frame associated with the language ID event that first indicated the second language as the predicted language may occur earlier in the sequence of input audio frames than the corresponding input audio frame associated with the one of the language ID events that includes the probability score satisfying the confidence threshold.

In some implementations, the operations further include, based on the determination that the language ID events are indicative of the utterance including the language switch from the first language to the second language, setting a rewind audio buffer pin to the time of the corresponding input audio frame associated with the language ID event that first indicated the second language as the predicted language. Here, rewinding the audio data buffered by the audio buffer includes causing the audio buffer to rewind the buffered audio data responsive to setting the rewind audio buffer pin to the time of the corresponding input audio frame associated with the language ID event that first indicated the second language as the predicted language.

In some examples, each speech recognition event including the respective speech recognition result in the first language further includes an indication that the respective speech recognition result includes a partial result or a final result. In these examples, the operations may further include determining that the indication for the respective speech recognition result of the speech recognition event for the corresponding input audio frame associated with the last language ID event to indicate the first language as the predicted language includes a partial result and setting a forced emit pin to a time of the corresponding input audio frame associated with the last language ID event to indicate the first language as the predicted language, thereby forcing the emitting of the first transcription of the first portion of the utterance. The first language pack and the second language pack may each include at least one of an automated speech recognition (ASR) model, an external language model, neural network types, an acoustic encoder, components of a speech recognition decoder, or the language ID predictor model.

The details of one or more implementations of the disclosure are set forth in the accompanying drawings and the description below. Other aspects, features, and advantages will be apparent from the description and drawings, and from the claims.

### DESCRIPTION OF DRAWINGS

FIGS. 1A and 1B are schematic views of an example system integrating a multilingual speech service into an application executing on a client device.

FIG. 2A is a schematic view of an example transcription of an utterance transcribed from audio data using a first speech recognition model for a first language after speech for a different second language is detected in the audio data.

FIG. 2B is a schematic view of the example transcription of FIG. 2A corrected by rewinding buffered audio data to when the speech for the different second language was detected in the audio data and re-transcribing a portion of the utterance by performing speech recognition on the rewound buffered audio data using a second speech recognition model for the second language.

FIGS. 3A and 3B are a schematic view of example transcriptions of an example utterance transcribed by rewinding buffered audio data to a time when a switch from speech spoken in a first language to a different second language was detected in the audio data.

FIG. 4 is a schematic view an example transcription of the same exemplary utterance of FIGS. 3A and 3B transcribed by rewinding the buffered audio to a time of a corresponding input audio frame associated with a language ID event that first indicated a new language as a predicted language.

FIG. 5 is a flowchart of an example arrangement of operations for a method of performing speech recognition on a code-switched utterance.

FIG. 6 is a schematic view of an example computing device that may be used to implement the systems and methods described herein.

Like reference symbols in the various drawings indicate like elements.

### DETAILED DESCRIPTION

Speech service technologies such as automatic speech recognition are being developed for on-device use where speech recognition models trained via machine learning techniques are configured to run entirely on a client device without the need to leverage computing resources in a cloud computing environment. The ability to run speech recognition on-device drastically reduces latency and can further improve the overall user experience by providing “streaming” capability where speech recognition results are emitted in a streaming fashion and can be displayed for output on a screen of the client device in a streaming fashion. On-device capability also provides for increased privacy since user data is kept on the client device and not transmitted over a network to a cloud computing environment. Moreover, many users prefer the ability for speech services to provide multilingual speech recognition capabilities so that speech can be recognized in multiple different languages.

Implementations herein are directed toward speech service interfaces for integrating one or more on-device speech service technologies into the functionality of an application configured to execute on a client device. Example speech service technologies may be “streaming” speech technologies and may include, without limitation, multilingual speech recognition, speaker turn detection, and or speaker diarization (e.g., speaker labeling). More specifically, implementations herein are directed toward a speech service interface providing events output from a multilingual speech recognition service for use by an application executing on a client device. The communication of the events between the application and the multilingual speech recognition service interface may be facilitated via application programming interface (API) calls. Other types of software intermediary interface calls may be employed to permit the on-device application to interact with the on-device multilingual speech recognition service. For example, the application executing on the client device may be implemented in a first type of code and the multilingual speech recognition service may be implemented in a second type of code different than the first type of code, wherein the API calls (or other types of software intermediary interface calls) may facilitate the communication of the events from the multilingual speech recognition service interface. In a non-limiting example, the first type of code implementing the speech service interface may include one of Java, Kotlin, Swift, or C++and the second type of code implementing the application may include one of Mac OS, iOS, Android, Windows, or Linux.

The client device may store a language pack directory that maps a primary language code to an on-device path of a primary language pack of the multilingual speech service to load onto the client device for use in recognizing speech directed toward the application in a primary language specified by the primary language code. The same language pack directory or a separate multi-language language pack directory may map each of one or more codeswitch language codes to an on-device path of a corresponding candidate language pack. Here, each corresponding candidate language pack is configured to recognize speech after a switch to a respective particular language specified by the corresponding codeswitch language code is detected by a language identification (ID) predictor model provided by the multilingual speech service and enabled for execution on the client device.

When the application is running on the client device and the client device captures audio data characterizing an utterance of speech directed toward the application (e.g., a voice command instructing the application to perform an action/operation, dictated speech, or speech intended for a recipient during a voice/video call facilitated by the application) in a primary language, the language ID predictor model processes the audio data to determine that the audio data is associated with the primary language code and the client device uses the primary language pack loaded thereon to process the audio data to determine a transcription of the utterance that includes one or more words in the primary language. The speech service interface may provide the transcription emitted from the multilingual speech service as an “event” to the application that may cause the application to display the transcription on a screen of the client device.

Advantageously, the multilingual speech recognition service permits the recognition of codeswitched utterances where the utterance spoken by a user may include speech that codemixes between the primary language and one or more other languages. In these scenarios, the language ID predictor model continuously processes incoming audio data captured by the client device and may detect a codeswitch from the primary language to a particular language upon determining the audio data is associated with a corresponding one of the one or more codeswitch language codes that specifies the particular language. As a result detecting the switch to the new particular language, the corresponding candidate language pack for the new particular language loads (i.e., from memory hardware of the client device) onto the client device for use by the multilingual speech recognition service in recognizing speech in the respective particular language. Here, the client device may use the corresponding candidate language pack loaded onto the client device to process the audio data to determine a transcription of the codeswitched utterance that now includes one or more words in the respective particular language.

When the multilingual speech recognition service decides to switch to a new language pack for recognizing speech as a result of detecting the language switch to a new particular language, there may be a delay in time for the speech service interface to load the new language pack into the execution environment for recognizing speech in the new language. As a result of this delay, the multilingual speech recognition service may continue to use the language pack associated with the previously identified language to process the input audio data until the switch to the correct new language pack is complete (i.e., the new language pack is successfully loaded into the execution environment), thereby resulting in recognition of words in an incorrect language. To account for the delay in the time it takes for the speech service interface to load the new language pack into the execution environment, an audio buffer may rewind buffered audio data relative to a time when the codeswitch from the first language to the new language was predicted in the incoming audio data so that the new language pack for the correct new language can commence processing the rewound buffered audio data once the switch to the new language pack is complete (i.e., successfully loaded).

The multilingual speech recognition service may be configured to emit speech recognition results as transcriptions of utterances when the speech recognition results are deemed final results. In the above scenario when detection of a language switch causes a new language pack to load into the execution environment, configuring the audio buffer to rewind buffered audio data to a time of the last final speech recognition event prior to detecting the switch to the new language assumes that the codeswitch in speech completes after the final result. While this assumption may hold true when there is a sufficient pause after the final result that delineates speech in the first language from speech in the new language, it does not always hold true in scenarios where there is no pause or a minimal pause when the codeswitch in speech actually occurs. That is, omission of the pause (or slight pause) separating the switch in speech from the first language to the second language may result in the speech recognition results immediately prior to the language switch being labeled as partial speech recognition results that ultimately get dropped due the rewinding of the buffered audio data to the earlier last final result despite there being additional speech spoken in the first language after the last final result. Not only are these dropped partial speech recognition results removed from the transcription, but the new language pack will be performing speech recognition on a portion of the buffered audio data that includes speech spoken in the first language, and thus, return gibberish results. To prevent these undesirable outcomes due to rewinding buffered audio too much, implementations herein are directed toward rewinding the buffered audio data to a time in the audio data when the codeswitch is first detected (albeit low confidence) and emitting the speech recognition results for all portions of the input audio data that include the first language as the predicted language even though some of these speech recognition results may be initially deemed partial speech recognition results occurring after a speech recognition event where the respective speech recognition result is deemed a final result.

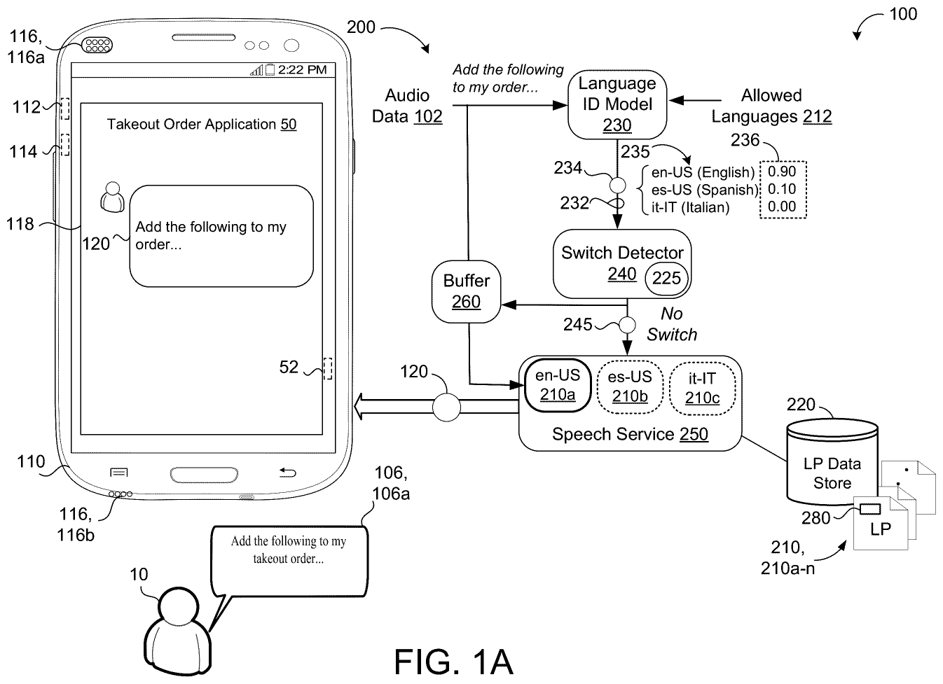

FIGS. 1A and 1B show an example of a system 100 operating in a speech environment. In the speech environment, a user's 10 manner of interacting with a client device, such as a user device 110, may be through voice input. The user device 110 is configured to capture sounds (e.g., streaming audio data) from one or more users 10 within the speech environment. Here, the streaming audio data may refer to a spoken utterance 106 by the user 10 that functions as an audible query, a command for the user device 110, or an audible communication captured by the user device 110. Speech-enabled systems of the user device 110 may field the query or the command by answering the query and/or causing the command to be performed/fulfilled by one or more downstream applications 50.

The user device 110 may correspond to any computing device associated with a user 10 and capable of receiving audio data or other user input. Some examples of user devices 110 include, but are not limited to, mobile devices (e.g., mobile phones, tablets, laptops, etc.), computers, wearable devices (e.g., smart watches, headsets, smart headphones), smart appliances, internet of things (IoT) devices, vehicle infotainment systems, smart displays, smart speakers, etc. The user device 110 includes data processing hardware 112 and memory hardware 114 in communication with the data processing hardware 112 and stores instructions, that when executed by the data processing hardware 112, cause the data processing hardware 112 to perform one or more operations. The user device 110 further includes an audio system 116 with an audio capture device (e.g., microphone) 116, 116a for capturing and converting spoken utterances 106 within the speech environment into electrical signals and a speech output device (e.g., a speaker) 116, 116b for communicating an audible audio signal (e.g., as output audio data from the user device 110). While the user device 110 implements a single audio capture device 116a in the example shown, the user device 110 may implement an array of audio capture devices 116a without departing from the scope of the present disclosure, whereby one or more capture devices 116a in the array may not physically reside on the user device 110, but be in communication with the audio system 116.

The user device 110 may execute a multilingual speech recognition service (MSRS) 250 entirely on-device without having to leverage computing services in a cloud-computing environment. By executing the MSRS 250 on-device, the multiannual speech service 250 may be personalized for the specific user 10 as components (i.e., machine learning models) of the MSRS 250 learn traits of the user 10 through on-going process and update based thereon. On-device execution of the MSRS 250 further improves latency and preserves user privacy since data does not have to be transmitted back and forth between the user device 110 and a cloud-computing environment. By the same notion, the MSRS 250 may provide streaming speech recognition capabilities such that speech is recognized in real-time and resulting transcriptions are displayed on a graphical user interface (GUI) 118 displayed on a screen of the user device 110 in a streaming fashion so that the user 10 can view the transcription as he/she is speaking. The MSRS 250 multilingual speech recognition capabilities to recognize speech spoken in multiple different languages and/or dialects including utterances of codemixed speech that include at least two different languages. In the example shown, the user device 110 stores a plurality of language packs 210, 210a-n in a language pack (LP) datastore 220 stored on the memory hardware 114 of the user device 110. The user device 110 may download the language packs 210 in bulk or individually as needed. In some examples, the MSRS 250 is pre-installed on the user device 110 such that one or more of language packs 210 in the LP datastore 220 are stored on the memory hardware 114 at the time of purchase.

In some examples, each language pack (LP) 210 includes resource files configured to recognize speech in a particular language. For instance, one LP 210 may include resource files for recognizing speech in a native language of the user 10 of the user device 110 and/or the native language of a geographical area/local the user device 110 is operating. Accordingly, the resource files of each LP 210 may include one or more of a speech recognition model, parameters/configuration settings of the speech recognition model, an external language model, neural networks, an acoustic encoder (e.g., multi-head attention/based, cascaded encoder, etc.), components of a speech recognition decoder (e.g., type of prediction network, type of joint network, output layer properties, etc.), or a language identification (ID) predictor model 230.

An operating system 52 of the user device 110 may execute a software application 50 on the user device 110. The user device 110 use a variety of different operating systems 52. In examples where a user device 110 is a mobile device, the user device 110 may run an operating system including, but not limited to, ANDROID® developed by Google Inc., IOS® developed by Apple Inc., or WINDOWS PHONE® developed by Microsoft Corporation. Accordingly, the operating system 52 running on the user device 110 may include, but is not limited to, one of ANDROID®, IOS®, or WINDOWS PHONE®. In some examples a user device may run an operating system including, but not limited to, MICROSOFT WINDOWS® by Microsoft Corporation, MAC OS® by Apple, Inc., or Linux.

A software application 50 may refer to computer software that, when executed by a computing device (i.e., the user device 110), causes the computing device to perform a task. In some examples, the software application 50 may be referred to as an “application”, an “app”, or a “program”. Example software applications 50 include, but are not limited to, word processing applications, spreadsheet applications, messaging applications, media streaming applications, social networking applications, and games. Applications 50 can be executed on a variety of different user devices 110. In some examples, applications 50 are installed on the user device 50 prior to the user 10 purchasing the user device 50. In other examples, the user 10 may download and install applications 50 on the user device 110.

Implementations herein are directed toward the user device 110 executing a speech service interface 200 for integrating the functionality of the MSRS 250 into the software application 50 executing on the user device 110. In some examples, the speech service interface 200 includes an open-sourced API that is visible to the public to allow application developers to integrate the functionality of the MSRS 250 into their applications. In the example shown, the application 50 includes a meal takeout application 50 that provides a service to allow the user 10 to place orders for takeout meals from a restaurant. More specifically, the speech service interface 200 integrates the functionality of the MSRS 250 into the application 50 to permit the user 10 to interact with the application 50 through speech such that the user 10 can provide spoken utterances 106 to place a meal order in an entirely hands free manner. Advantageously, the MSRS 250 may recognize speech in multiple languages and be enabled for recognizing codeswitched speech where the user speaks an utterance in two or more different languages. For instance, the meal takeout application 50 may allow the user 10 to place orders for takeout meals through speech (i.e., spoken utterances 106) from El Barzon, a restaurant located in Detroit, Michigan that specializes in upscale Mexican and Italian fare dishes. While the user 10 may speak English as a native language (or it can be generally assumed that users using the application 50 for the Detroit-based restaurant are native speakers of English), the user 10 is likely to speak Spanish words when selecting Mexican dishes and/or Italian words when selecting Italian dishes to order from the restaurant's menu.

The speech service interface 200 includes a language pack directory 225 that maps a primary language code 235 to an on-device path of a primary language pack 210 of the multilingual speech recognition service 250 to load onto the user device 110 for use in recognizing speech directed toward the application 50 in a primary language specified by the primary language code 235. In short, the language pack directory 225 contains the path to all the necessary resource files stored on the memory hardware 114 of the user device 110 for recognizing speech in particular language. In some examples, the application 50 explicitly enables multi-language speech recognition by specifying the primary language code 235 for a primary locale within the language pack directory 225. The language pack directory 225 may also map each of one or more codeswitch language codes 235 to an on-device path of a corresponding candidate language pack 210. Here, each corresponding candidate language pack 210 is configured to recognize speech after a switch to a respective particular language specified by the corresponding codeswitch language code 235 is detected by a language identification (ID) predictor model 230. In some examples, the language pack directory 225 provides an on-device path of the language pack 210 that contains the language ID predictor model 230. The application 50 may provide the language pack directory 225 based on a geographical area the user device 110 is located, user preferences specified in a user profile accessible to the application, or default settings of the application 50.

The language ID predictor model 230 may support identification of a multitude of different languages from input audio data. The present disclosure is not limited to any specific language ID predictor model 230, however the language ID predictor model 230 may include a neural network trained to predict a probability distribution over possible languages for each of a plurality of audio frames segmented from input audio data 102 and provided as input to the language ID predictor model 230 at each of a plurality of time steps. In some examples, the language codes 235 are represented in BCP 47 format (e.g., en-US, es-US, it-IT, etc.) where each language code 11 specifies a respective language (e.g., en for English, es for Spanish, it for Italian, etc.) and a respective local (e.g., US for United States, IT for Italy, etc.). In some implementations, the respective particular language specified by each codeswitch language code 235 supported by the language ID predictor model 230 is different than the respective particular language specified by each other codeswitch language code in the plurality of codeswitch language codes 235. Each language pack 210 referenced by the language pack directory 225 may be associated with a respective one of the language codes 235 supported by the language ID predictor model 230. In some examples, the speech service interface 200 permits the language codes 235 and language packs 210 to only include one locale per language (e.g., only es-US not both es-US and es-ES).

In some examples, the language ID predictor model 230 receives a list of allowed languages 212 that constrains the language ID predictor model 230 to only predict language codes 235 that specify languages from the list of allowed languages 212. Thus, while the language ID predictor model 230 may support a multitude of different languages, the list of allowed languages 212 optimizes performance of the language ID predictor model 230 by constraining the model 210 to only consider language predations for those languages in the list of allowed languages 210 rather than each and every language supported by the language ID predictor model 230. For instance, in the example of FIGS. 1A and 1B where the application 50 includes the meal takeout application for ordering Mexican and Italian meals from El Barzon restaurant, the application 50 may provide a list of allowed languages 212 that includes English, Spanish, and Italian. Here, the application 50 may designate Spanish and Italian as allowed languages based on the meal items on the menu available for order having Spanish and Italian names. On the other hand, the application 50 may designate English as an allowed language since the user 10 speaks English as a native language. However, if the application 50 ascertained from user profile settings of the user device 110 that the user 10 is a bilingual speaker of both English and Hindi, the application 50 may also designate Hindi as an additional allowed language. By the same notion, when the same meal takeout application 50 is executing on a different user device associated with another user who only speaks Spanish, the application 50 may provide configuration parameters 211 that include a list of allowed languages that only includes Spanish and Italian.

In some configurations, the language ID predictor model 230 is configured to provide a probability distribution 234 over possible language codes 235. Here, the probability distribution 234 is associated with a language ID event 232 and includes a probability score 236 assigned to each language code indicating a likelihood that the corresponding input audio frame 102 corresponds to the language specified by the language code 235. As described in greater detail below, the language ID predictor model 230 may rank the probability distribution 234 over possible languages 235 and a language switch detector 240 may predict a codeswitch to a new language when a new language code 235 is ranked highest and its probability score 236 satisfies a confidence threshold. In some scenarios, the language switch detector 220 defines different magnitudes of confidence thresholds to determine different levels of confidence in language predictions of each audio frame 102 input to the language ID predictor model 230. For instance, the language switch detector 220 may determine that a predicted language for a current audio frame 102 is highly confident when the probability score 236 associated with the language code 235 specifying the predicted language satisfies a first confidence threshold or confident when the probability score satisfies a second confidence threshold having a magnitude less than the first confidence threshold. Additionally, the language switch detector 220 may determine that the predicted language for the current audio frame 102 is less confident when the probability score satisfies a third threshold having a magnitude less than both the first and second confidence thresholds. In a non-limiting example, the third confidence threshold may be set at 0.5, the first confidence threshold may be set at 0.85, and the second confidence threshold may be set at some value having a magnitude between 0.5 and 0.85.

In some implementations, the language ID predictor model 230 includes a codeswitch sensitivity indicating a confidence threshold that a probability score 236 for a new language code 235 predicted by the language ID predictor model 230 in the probability distribution 234 must satisfy in order for the speech service interface 200 to attempt to switch to a new language pack. Here, the codeswitch sensitivity includes a value to indicate the confidence threshold that the probability score 236 must satisfy in order for the language switch detector 240 to attempt to switch to the new language pack by loading the new language pack 210 into an execution environment for performing speech recognition on the input audio data 102. In some examples, the value of the codeswitch sensitivity includes a numerical value that must be satisfied by the probability score 236 associated with the highest ranked language code 235. In other examples, the value of the codeswitch sensitivity is an indication of high precision, balanced, or low reaction time each correlating to a level of confidence associated with the probability score 236 associated with the highest ranked language code 235. Here, a codeswitch sensitivity set to ‘high precision’ optimizes the speech service interface 200 for higher precision of the new language code 235 such that speech service interface 200 will only make the attempt to switch to the new language pack 210 when the corresponding probability score 236 is highly confident. The application 50 may set the codeswitch sensitivity to ‘high precision’ by default where false-switching to the new language pack would be annoying to the end user 10 and slow-switching is acceptable. Setting the codeswitch sensitivity to ‘balanced’ optimizes the speech service interface 200 to balance between precision and reaction time such that the speech service interface 200 will only attempt to switch to the new language pack 210 when the corresponding probability score 236 is confident. Conversely, in order to optimize for low reaction time, the application 50 may set the codeswitch sensitivity to ‘low reaction time’ such that the speech service interface 200 will attempt to switch to the new language pack regardless of confidence as long as the highest ranked language code 235 is different than the language code 235 that was previously ranked highest in the probability distribution 234 (i.e., language id event) output by the language ID predictor model 235. The application 50 may set the codeswitch sensitivity to ‘low reaction time’ when slow switches to new language packs are not desirable and false-switches are acceptable. The application 50 may periodically update the codeswitch sensitivity. For instance, a high frequency of user corrections may fixing false-switching events may cause the application 50 to increase the codeswitch sensitivity to reduce the occurrence of future false-switching events at the detriment of increased reaction time.

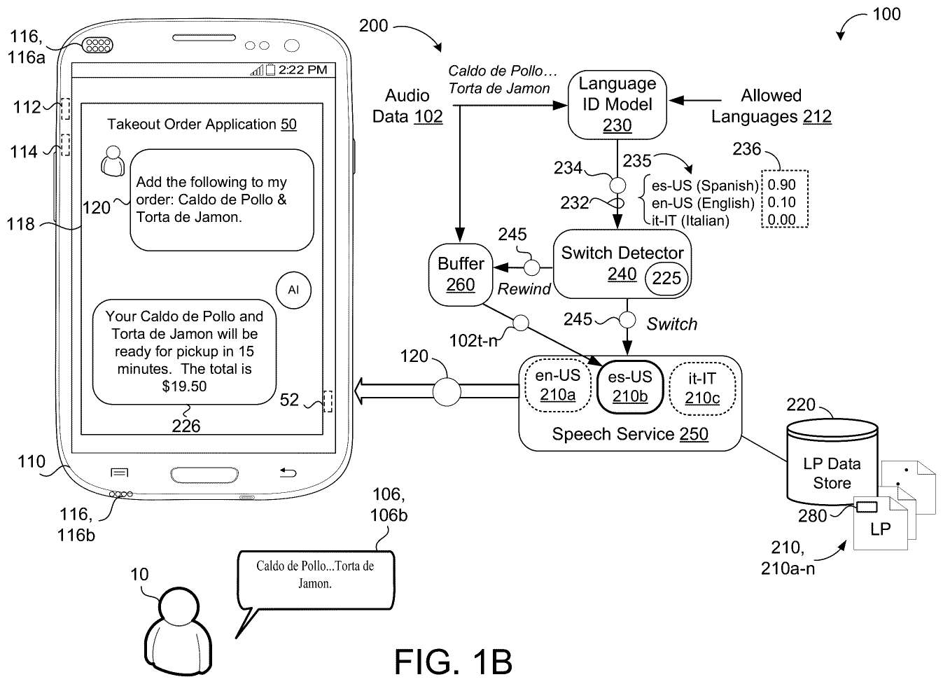

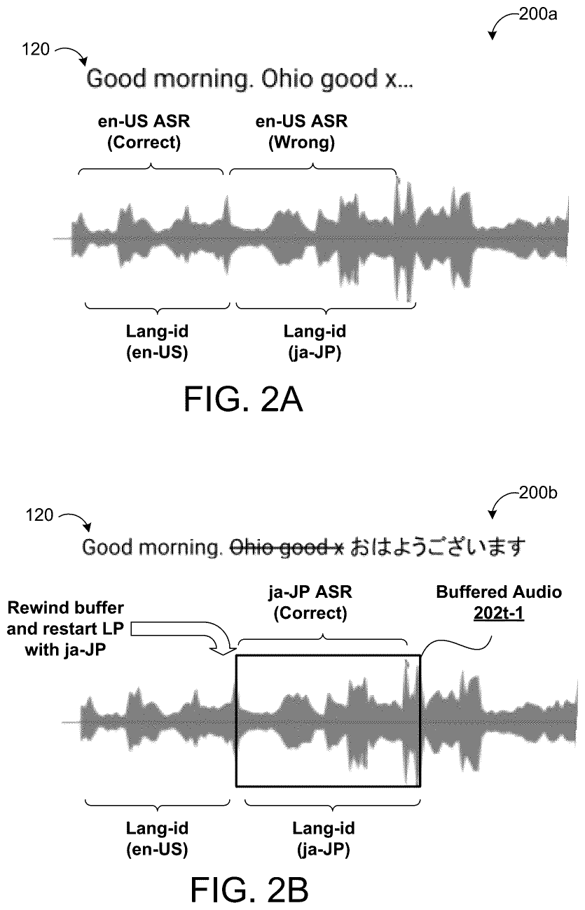

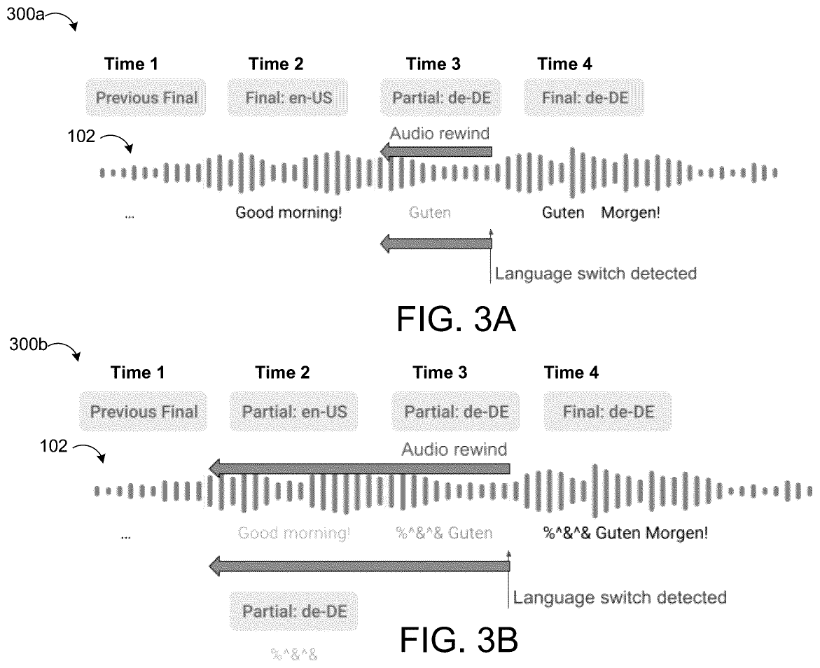

When the speech service interface 200 decides, based on a switching decision 245 output by the language switch detector 240, to switch to a new language pack 210 for recognizing speech, there may be a delay in time for the speech service interface 200 to load the new language pack 210 into the execution environment for recognizing speech in the new language. As a result of this delay, the MSRS 250 may continue to use the language pack 210 associated with the previously identified language to process the input audio data 102 until the switch to the correct new language pack 210 is complete, thereby resulting in recognition of words in an incorrect language. Furthermore, the language ID predictor model 230 may take a few seconds to accumulate enough confidence in probability scores for new language codes ranked highest in the probability distribution 234. To account for the delay in the time it takes for the speech service interface 200 to load the new language pack 210 into the execution environment, the MSRS 250 may arbitrarily set a rewind audio buffer pin to the time of an input audio frame that first predicted the new language. Described in greater detail below with reference to FIGS. 2A, 2B, 3A, and 3B, the setting of the rewind audio buffer pin causes an audio buffer 260 to rewind buffered audio data 102 relative to a time when the language ID predictor model 210 first predicted the new language code 215 associated with a new language pack 210 the speech service interface 200 is switching to so that the new language pack 210 for the correct language can commence processing the rewound buffered audio data once the switch to the new language pack 210 is complete (i.e., successfully loaded). Notably, setting the rewind audio buffer pin in this arbitrary manner is based on the assumption that the top predicted language usually changes to the new language before the probability score 236 of the top predicted language code 235 satisfies the confidence threshold necessary to make the switching decision. Accordingly, the time of the input audio frame 102 associated with the language ID event 235 that first indicated the predicted language change to the new language (i.e., the language code 235 specifying the new language code includes the highest probability score 236 in the probability distribution 234) is a good indicator of when the language change occurs even though the confidence is not yet high enough to make the switching decision. As such, the MSRS 250 is configured to make a switching decision 245 to switch to the new language pack 210 when the probability score 236 of the top predicted language code 235 specifying the new language satisfies the confidence threshold, and set the rewind audio buffer pin to cause the audio buffer 260 to rewind buffered audio data 102 relative to the time when the language ID predictor model 210 first predicted the new language code 235 as the top predicted language code in the probability distribution 234 over possible language codes 235.

For applications 50 where input utterances to be recognized are relatively short, incorrectly recognizing words due to using the previous language pack 210 before a switch to a new language pack 210 is complete may be equivalent to misrecognizing the entire utterance. Similarly, in an application 50 such as an open-mic translation application translating utterances captured in a multilingual conversation, recognizing words in a wrong language during each speaker turn can add up to a lot of misrecognized words in the entire conversation.

FIG. 2A provides a schematic view 200a of an example transcription 120 of an utterance transcribed from audio data 102 using a first speech recognition model for a first language after a switch to a second language is detected. Here, the first speech recognition model may include a resource in a first language pack for recognizing speech in English and the United States locale. A first portion of the utterance may be spoken in English where the first speech recognition model for the first language of English correctly transcribes the utterance in English. Here, the language ID predictor model 230 outputs a language ID event 232 that predicts the language code en-US for the first portion of the utterance. A second portion of the utterance spoken in Japanese is processed by the language ID predictor model 230 to output a language ID event 232 that predicts the language code ja-JP. Assuming that the language ID event 232 results in a switching decision to a new language, FIG. 2A shows the first speech recognition model for the first language of English processing the second portion of the utterance spoken in Japanese resulting in the recognition of words in the wrong language. This is the result of the time delay that occurs for a new language pack including a second speech recognition model for the second language of Japanese to successfully load. That is, while the new language pack including the correct speech recognition model is loading, the MSRS 250 may continue to use the previously loaded language pack, thereby resulting in recognition of words in an incorrect language.

FIG. 2B is a schematic view of the example transcription of FIG. 2A corrected by rewinding buffered audio data to a time when the speech for the different second language was detected in the audio data. Here, the speech service interface 200 retrieves the buffered audio data rewound to the appropriate location, whereby the second speech recognition for the second language of Japanese commences processing of the buffered audio data once the new language pack is successfully loaded. Accordingly, the MSRS 250 may accurately transcribe the second portion of the utterance spoken in Japanese by performing speech recognition on the rewound buffered audio data using a second speech recognition model for the second language.

The MSRS 250 may be configured to emit speech recognition results as transcriptions of utterances when the speech recognition results are deemed final results. The resources within given language packs 210 while performing speech recognition on the input audio data 102 may be trained to output speech recognition events that indicate whether a corresponding speech recognition result output at a corresponding time step includes a partial result or a final result. The resources of the language packs 210 that may determine whether the speech recognition result at a given time step is partial or final may include any combination of a speech recognition model trained to label speech recognition results generated at each time step as partial results or final results, an endpointer trained to determine when an end of speech segment occurs, or a voice activity detector.

FIG. 3A provides a schematic view 300a of an example transcription 120 of another example utterance transcribed by rewinding buffered audio data to a time when a switch from speech spoken in a first language (e.g., English) to a different second language (e.g., German) was detected in the audio data 102. A first portion of the utterance may be spoken in English where a first speech recognition model (i.e., first language pack) for the first language of English correctly transcribes the utterance in English. Here, the language ID predictor model 230 outputs a language ID event 232 that predicts the language code en-US for the first portion of the utterance. A second portion of the utterance spoken in German is processed by the language ID predictor model 230 to output a language ID event 232 that predicts the language code de-DE. Each block may represent a language ID event 232 (FIGS. 1A and 1B) and a speech recognition event. Each language ID event indicates a predicted language for an input audio frame 102 at a corresponding time (Time 1, Time 2, Time 3, and Time 4). The language ID events 232 at each of the times indicate the top predicted language code without indicating the level of confidence of the language prediction. Each speech recognition event includes a speech recognition result in the respective language determined by the current speech recognition model and an indication that the respective speech recognition result in the respective language includes a partial result or a final result. A language switch is detected at Time 3 based on the language ID event 232 predicting the language code de-DE as the top predicted language and having a probability score 236 that satisfies the confidence threshold. Initially, the first speech recognition model processes the input audio segment at Time 3 to generate a partial recognition result in the first language (English) even though the language ID event 232 at Time 3 detected the language switch to the second language (German). As a result of the language switch, the MSRS 250 loads the second speech recognition model for recognizing speech in the second language (e.g., German). In the example of FIG. 3A, when detection of the language switch causes the second speech recognition model to load into the execution environment, the audio buffer 260 rewinds the buffered audio data 102 to a time between Time 2 and Time 3 where the last respective speech recognition result in the previous first language is indicated as a final result. Configuring the audio buffer 260 to rewind buffered audio data 102 to a time of the last speech recognition event where the respective speech recognition result is in the previous first language and the respective speech recognition result is indicated as a final result assumes that the codeswitch in speech completes after the final result. In the example of FIG. 3A, this assumption holds true since the language ID event 230 indicates a change in the predicted language from English to German at Time 3 immediately after the last speech recognition event at Time 2 where the respective speech recognition result in the previous first language is indicated as the final result. The MSRS 250 may correctly emit a first transcription (e.g., Good Morning!) corresponding to the first portion of the utterance spoken in English that was determined by the first speech recognition model and perform speech recognition on the rewound buffered audio data 102 commencing at Time 3 to generate a second transcription (e.g., Guten Morgen!) corresponding to the second portion of the utterance spoken in German.

By contrast, FIG. 3B provides a schematic view 300b where the transcription 120 of the codemixed utterance is incorrectly recognized since rewinding the buffered audio data to the last speech recognition event indicated as a final result results in rewinding the buffered audio data too much. In this example, the last speech recognition event indicated as the final result occurs between Times 1 and 2 and the subsequent speech recognition event at Time 3 is now indicated as a partial result. Yet, the language ID event 232 at Time 2 predicts the first language (English) as the top predicted language and changes to predict the second language (German) as the top predicted language at Time 3. In this case, the respective speech recognition result for the audio segment at Time 2 is likely indicated as the partial result instead of a final result due to there being an insufficient pause at the time the codeswitch in speech actually occurs between Time 2 and Time 3. Time 2. The example of FIG. 3B shows that the rewinding of the buffered audio data to the last speech recognition result indicated as the final result after Time 1 effectively causes the partial speech recognition result at Time 2 for speech actually spoken in the first language to be dropped and never emitted. Additionally, once the second language model for recognizing speech in the second language is successfully loaded, the second language model will initially produce a transcription that includes gibberish results (%\hat{ }&\hat{ }&) since the second language model will commence processing the rewound buffered audio data starting at Time 2 which includes speech spoken in the first language.

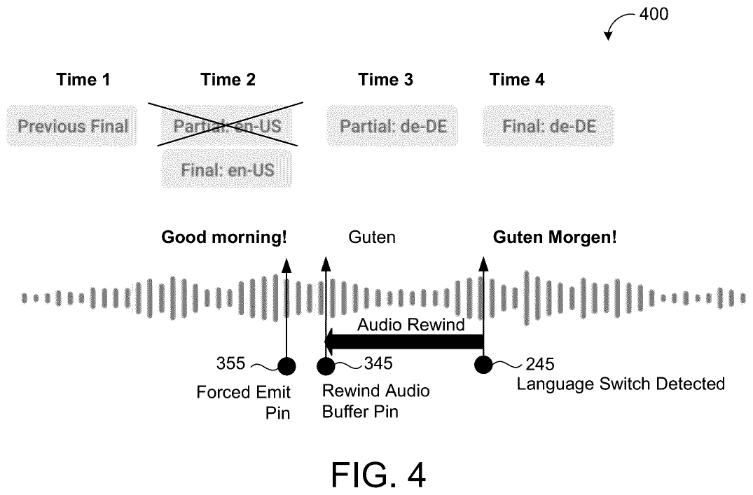

FIG. 4 provides a schematic view 400 of an example transcription of the same exemplary utterance of FIGS. 3A and 3B where, after detecting the language switch from the first language (English) to the second language (German) at Time 3,the MSRS 250 is instead configured to rewind the buffered audio to a time (Time 3) of the corresponding input audio frame associated with the language ID event that first indicated the second language as the predicted language. Thus, based on a determination that the language ID event at Time 3 is indicative of the utterance including the language switch from the first language to the second language, the MSRS 250 sets a rewind audio buffer pin 345 to the time (commencing at Time 3) of the corresponding input audio frame associated with the language ID event that first indicated the second language as the predicted language. Here, the setting of the rewind audio buffer pin 345 responsively causes the audio buffer 260 to rewind the buffered audio data to the time of the corresponding input audio frame (commencing at Time 3) associated with the language ID event that first indicated the second language as the predicted language. By rewinding the buffered audio data to the time of the corresponding input frame associated with the language ID event that first indicated the second language as the predicted language, the MSRS 250 may commence processing the rewound buffered audio data to generate a transcription for the portion of the utterance spoken in the second language without processing audio that may have been spoken prior to the language switch as in the example depicted in FIG. 3B.

While the example shown infers that the audio frame at Time 3 predicts the second language with a probability score 236 that satisfies the confidence threshold since the language switch is detected, the language ID event for the audio frame that first indicated the second language as the predicted language may include any confidence level so long as the second language is the top predicted language. Thus, if the example shown included the language ID event 232 for the corresponding audio frame at Time 2 instead predicting the second language (German) as the top predicted language with a probability score 236 not high enough to satisfy the confidence threshold, the MSRS 250 would set the rewind audio buffer pin 345 to the time of the corresponding input audio frame (commencing at Time 2) after detecting the language switch at Time 3 once the confidence level (i.e., based on the highest probability score 236) of the language prediction is high enough to satisfy the confidence threshold.

With continued reference to FIG. 4, the detection of the language switch from the first language to the second language also causes the MSRS 250 to change (e.g., overwrite) the indication from a partial result to a final result for the respective speech recognition result associated with the language ID event that last predicted the first language as the predicted language. In doing so, the MSRS 250 will now force emit the speech recognition result at Time 2 associated with the language ID event that last predicted the first language as the predicted language as a first transcription of the first portion of the utterance. For instance, FIG. 4 shows the MSRS 250 determining that the indication for the respective speech recognition result of the speech recognition event for the corresponding input audio frame at Time 2 that is associated with the last language ID event to indicate the first language as the predicted language includes a partial result likely due to a short or non-existent pause in speech when the language switch occurred between times 2 and 3. As such, the MSRS 250 sets a forced emit pin 355 to a time of the corresponding input audio frame associated with the last language ID event to indicate the first language as the predicted language at Time 2, thereby forcing the emitting of the first transcription of the first portion of the utterance to emit. Accordingly, and in contrast to the example of FIG. 3B where the partial speech recognition result at Time 2 for speech that was actually spoken in the first language was dropped and never emitted due to the rewinding of the buffered audio data too far, the setting of the forced emit pin 355 at the last time the first language was predicted correctly emits the first transcription for the first portion of the utterance by using the respective speech recognition results determined by the first language model for only the corresponding input audio frames (e.g., Times 1 and 2) associated language ID events that indicate the first language as the predicted language. In the example shown of FIG. 4, the setting of the rewind audio buffer pin 345 and the forced emit pin 355 as described above permits the first transcription for the first portion of the utterance (e.g., “Good morning!”) to correctly include all the words recognized by the first language model that were spoken in the first language (English) and a second transcription for the second portion of the utterance (e.g., “Guten Morgen!”) to correctly include all the words recognized by the second language model that were spoken in the second language (German) after the detection of the language switch.

Referring back to FIGS. 1A and 1B, in some examples, the speech service interface 200 and/or the application 50 causes the MSRS 250 to load an en-US language pack as a primary language pack 210a for use in recognizing speech directed toward the application 50 in the primary language of English. Notably, the primary language pack 210a is depicted as a dark solid line in FIG. 1A to indicate that the primary language pack 210a is loaded into an execution environment for recognizing incoming audio data 102. The candidate language packs 210b, 210c for Spanish and Italian, respectively are depicted as dashed lines to indicate that the candidate language packs 210b, 210c are currently not loaded in FIG. 1A. FIG. 1B depicts the candidate language pack 210b for recognizing speech in Spanish as a dark solid line to indicate that speech service interface 200 made a switching decision to now load the candidate language pack 210b, the primary language pack 210a and the other candidate language pack 210c are depicted as dashed lines to indicate they are not currently loaded for recognizing input audio data 102. Moreover, while the language ID predictor model 230 is shown as separate component from the language packs 210 of the MSRS 250 for simplicity, one or more of the language packs 210 may include the language ID predictor model 230 as a resource.

FIG. 1A shows the user 10 speaking a first portion 106a of an utterance 106 that is directed toward the meal takeout application 50 that includes the user 10 speaking “Add the following to my takeout order . . . ” in English. The user device 110 captures the audio data 102 characterizing the first portion 106a of the utterance 106. The audio data 102 may include a plurality of audio segments or audio frames that may be each provided as input to the MSRS 250 at a corresponding time step. The language ID predictor model 230 processes the audio data 102 to determine whether or not the audio data 102 is associated with the primary language code 235 of en-US. Here, the language ID predictor model 230 may process the audio data 102 at each of a plurality of time steps to determine a corresponding probability distribution 234 over possible language codes 235 at each of the plurality of time steps.

In the example shown, the application 50 may include a list of allowed languages 212 that constrains the language ID predictor model 230 to only predict language codes 235 that specify languages from the list of allowed languages 212. For instance, when the list of allowed languages 212 includes only English, Spanish, and Italian, the language ID predictor model 230 will only determine a probability distribution 234 over possible language codes 235 that include English, Spanish, and Italian. The probability distribution 234 may include a probability score 236 assigned to each language code 235. In some examples, the language ID predictor model 230 outputs the language ID event 232 indicating a predicted language for the audio frame 102 at the corresponding time and a level of confidence of the probability score 236 for the corresponding highest ranked language code 235 in the probability distribution 234 that specifies the predicted language. In the example shown, primary language code 235 of en-US is associated with a highest probability score in the probability distribution 234. A switch detector 240 receives the language ID event 232 and determines that the audio data 102 characterizing the utterance “Add the following to my order” is associated with the primary language code 235 of en-US. For instance, the switch detector 240 may determine that the audio data 102 is associated with the primary language code 235 when the probability score 236 for the primary language code 235 satisfies a confidence threshold. Since the switch detector 240 determines the audio data 102 is associated with the primary language code 235 that maps to the primary language pack 210a currently loaded for recognizing speech in the primary language, the switch detector 240 outputs a switching result 245 of No Switch to indicate that the current language pack 210a should remain loaded for use in recognizing speech. Notably, the audio data 102 may be buffered by the audio buffer 260 and the speech service interface may rewind the buffered audio data in scenarios where the switching result 245 includes a switch decision. FIG. 1A shows the speech service interface 120 providing a transcription 120 of the first portion 106a of the utterance 106 in English to the application 50. The application 50 may display the description 120 on the GUI 118 displayed on the screen of the user device 110.

FIG. 1B shows the user 10 speaking a second portion 106b of the utterance 106 that includes “Caldo de Pollo . . . Torta de Jamon” that includes Spanish words for Mexican dishes the user 10 is selecting to order from the restaurant's menu. The user device 110 captures additional audio data 102 characterizing the second portion 106b of the utterance 106 and the language ID predictor model 230 processes the additional audio data 102 to determine a corresponding probability distribution 234 over possible language codes 235 at each of the plurality of time steps. More specifically, the language ID predictor model 230 may output the language ID event 232 indicating a predicted language for the additional audio data at the corresponding time and a level of confidence of the probability score 236 for the corresponding highest ranked language code 235 in the probability distribution 234 that specifies the predicted language. Notably, the language ID event 232 associated with the additional audio data now indicates that the codeswitch language code 235 for es-US is ranked highest in the probability distribution 234.

The switch detector 240 receives the language ID event 232 for the additional audio data and determines that the additional audio data 102 characterizing the second portion 106b of the utterance “Caldo de Pollo. . . . Torta de Jamon” is associated with the codeswitch language code 235 of es-US. For instance, the switch detector 240 may determine that the additional audio data 102 is associated with the codeswitch language code 235 when the probability score 236 for the codeswitch language code 235 satisfies the confidence threshold. In some examples, a value for codeswitch sensitivity provided in the configuration parameters 211 indicates a confidence threshold that the probability score 236 for the codeswitch language code 235 must satisfy in order for the switch detector 240 to output a switch result 245 indicative of a switching decision (Switch). Here, the switch result 245 indicating the switching decision causes the speech service interface 200 to attempt to switch to the candidate language pack 210b for recognizing speech in the particular language (e.g., Spanish) specified by the codeswitch language code 235 of es-US.

The speech service interface 200 switches from the primary language pack 210a to the candidate language pack 210b for recognizing speech in the respective particular language by loading, from the memory hardware 114 of the user device 110, using the language pack directory 225 that maps the corresponding codeswitch language code 235 to the on-device path of the corresponding candidate language pack 210b of es-US, the corresponding candidate language pack 210b onto the user device 110 for use in recognizing speech in the respective particular language of Spanish. FIG. 1B shows the speech service interface 100 providing a transcription 120 of the second portion 106b of the utterance 106 in Spanish to the application 50. The application 50 may display update the transcription 120 displayed the GUI 118 to provide a final transcription that includes the entire codemixed utterance of Add the following to my order: Caldo de Pollo & Torta de Jamon. Notably, the speech service 250 may perform normalization on the final transcription 120 to add capitalization and punctuation.

The language ID event 232 output by the language ID predictor model 230, the switch result 245 output by the switch detector 240, and the transcription 120 output by the MMS 250 may all include corresponding events that the speech service interface 200 may provide to the application 50. In some examples, the speech service interface 200 provides one or more of the aforementioned events 234, 245, 120 as corresponding output API calls.

In the example of FIG. 1B, since the speech service interface 200 decides (i.e., based on the switch result 245 indicative of the switching decision output by the language switch detector 240) to switch to the new candidate language pack 210b for recognizing speech in the respective particular language (e.g, Spanish), there may be a delay in time for the speech service interface 200 to load the new candidate language pack 210b for es-US into the execution environment for recognizing speech in Spanish. To account for this delay, the switching decision specified by the switch result 245 may cause the audio buffer 260 to rewind buffered audio data 102t-1 relative to a time when the language ID predictor model 210 first predicted the codemixed language code 215 associated with the candidate language pack 210 the speech service interface 200 is switching to for recognizing speech in the correct language (e.g., Spanish) independent of the confidence of the prediction of the codemixed language code 215 as described above with reference to FIG. 4. Accordingly, the speech service interface 200 may retrieve the buffered audio data 102t-1 for use by the candidate language pack 210b once the switch to the candidate language pack 210b is complete (i.e., successfully loaded).

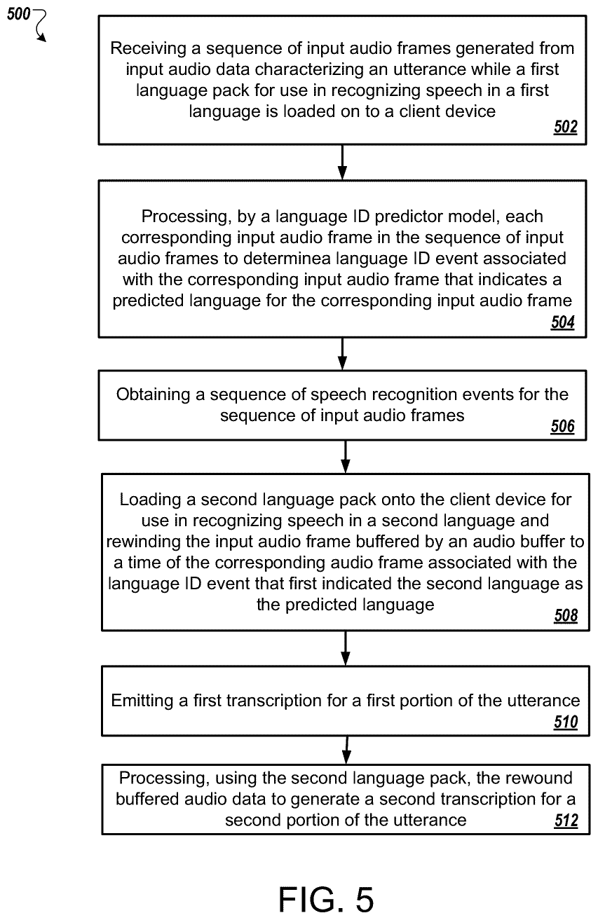

FIG. 5 is a schematic view of an example flowchart for an exemplary arrangement of operations for a method 500 of integrating a multilingual speech service 250 into an application 50 executing on a client device 110. The operations may execute on data processing hardware 112 of the client device 110 based on instructions stored on memory hardware 114 of the client device 110. At operation 502, while a first language pack 210 for use in recognizing speech in a first language is loaded on to the client device 110, the method 500 includes receiving a sequence of audio frames 102 generated from input audio data characterizing an utterance 106. At operation 504, the method includes processing, using a language ID predictor model 230, each corresponding input audio frame 102 to determine a language ID event 232 associated with the corresponding input frame 102 that indicates a predicted language for the corresponding input audio frame 102.

At operation 506, the method 500 includes obtaining a sequence of speech

recognition events for the sequence of input audio frames. Here each speech recognition event includes a respective speech recognition result in the first language determined by the first language pack 210 for a corresponding one of the input audio frames. At operation 508, based on determining that the language ID events 232 are indicative of the utterance 106 including a language switch from the first language to a second language, the method 500 includes loading, from memory hardware 114 of the client device 110, a second language pack 210 onto the client device 110 for use in recognizing speech in the second language and rewinding input audio data buffered by an audio buffer 260 to a time of the corresponding input audio frame 102 associated with the language ID event 232 that first indicated the second language as the predicted language.

At operation 510, the method 500 includes emitting, using the respective speech recognition results determined by the first language pack 210 for only the corresponding input audio frames 102 associated language ID events 232 that indicate the first language as the predicted language, a first transcription 120 for a first portion of the utterance 106. At operation 512, the method 500 includes processing, using the second language pack 210 loaded onto the client device 110, the rewound buffered audio data 102 to generate a second transcription 120 for a second portion of the utterance.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

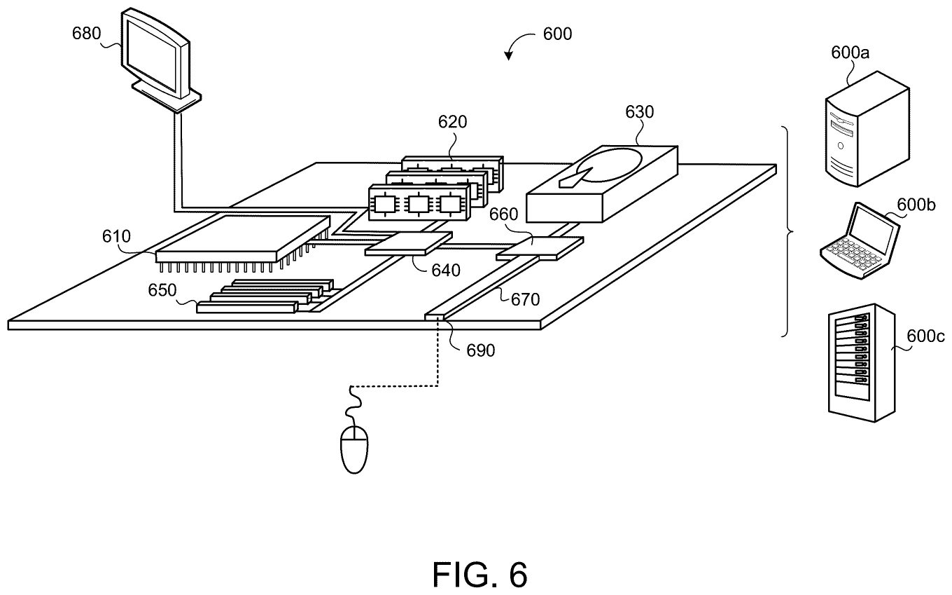

FIG. 6 is schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer- readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware of a client device that causes the data processing hardware to perform operations comprising:
while a first language pack for use in recognizing speech in a first language is loaded onto the client device, receiving a sequence of input audio frames generated from input audio data characterizing an utterance;
processing, by a language identification (ID) predictor model, each corresponding input audio frame in the sequence of input audio frames to determine a language ID event associated with the corresponding input audio frame that indicates a predicted language for the corresponding input audio frame;
obtaining a sequence of speech recognition events for the sequence of input audio frames, each speech recognition event comprising a respective speech recognition result in the first language determined by the first language pack for a corresponding one of the input audio frames;
based on determining that the language ID events are indicative of the utterance including a language switch from the first language to a second language:
loading, from memory hardware of the client device, a second language pack onto the client device for use in recognizing speech in the second language; and
rewinding the input audio data buffered by an audio buffer to a time of the corresponding input audio frame associated with the language ID event that first indicated the second language as the predicted language;
emitting, using the respective speech recognition results determined by the first language pack for only the corresponding input audio frames associated language ID events that indicate the first language as the predicted language, a first transcription for a first portion of the utterance; and
processing, using the second language pack loaded onto the client device, the rewound buffered audio data to generate a second transcription for a second portion of the utterance.

2. The computer-implemented method of claim 1, wherein:
the first transcription comprises one or more words in the first language; and
the second transcription comprises one or more words in the second language.

3. The computer-implemented method of claim 1, wherein the language ID event determined by the language ID predictor model that indicates the predicted language for each corresponding input audio frame further comprises a probability score indicating a likelihood that the corresponding input audio frame includes the predicted language.

4. The computer-implemented method of claim 3, wherein the operations further comprise:
determining that the probability score of one of the language ID events that indicates the first language as the predicated language satisfies a confidence threshold,
wherein determining that the language ID events are indicative of the utterance including the language switch from the first language to the second language is based on the determination that the probability score of the one of the language ID events that indicates the first language as the predicated language satisfies the confidence threshold.

5. The computer-implemented method of claim 4, wherein the probability score of the language ID event that first indicated the second language as the predicated language fails to satisfy the confidence threshold.

6. The computer-implemented method of claim 4, wherein the corresponding input audio frame associated with the language ID event that first indicated the second language as the predicted language occurs earlier in the sequence of input audio frames than the corresponding input audio frame associated with the one of the language ID events that comprises the probability score satisfying the confidence threshold.

7. The computer-implemented method of claim 1, wherein the operations further comprise:
based on the determination that the language ID events are indicative of the utterance including the language switch from the first language to the second language, setting a rewind audio buffer pin to the time of the corresponding input audio frame associated with the language ID event that first indicated the second language as the predicted language,
wherein rewinding the audio data buffered by the audio buffer comprises causing the audio buffer to rewind the buffered audio data responsive to setting the rewind audio buffer pin to the time of the corresponding input audio frame associated with the language ID event that first indicated the second language as the predicted language.

8. The computer-implemented method of claim 1, wherein each speech recognition event comprising the respective speech recognition result in the first language further comprises an indication that the respective speech recognition result comprises a partial result or a final result.

9. The computer-implemented method of claim 8, wherein the operations further comprise:
determining that the indication for the respective speech recognition result of the speech recognition event for the corresponding input audio frame associated with the last language ID event to indicate the first language as the predicted language comprises a partial result; and
setting a forced emit pin to a time of the corresponding input audio frame associated with the last language ID event to indicate the first language as the predicted language, thereby forcing the emitting of the first transcription of the first portion of the utterance.

10. The computer-implemented method of claim 1, wherein the first language pack and the second language pack each comprise at least one of:
an automated speech recognition (ASR) model;
parameters/configurations of the ASR model;
an external language model;
neural network types;
an acoustic encoder;
components of a speech recognition decoder; or
the language ID predictor model.

11. A system comprising:
data processing hardware; and
memory hardware storing instructions that when executed on the data processing hardware causes the data processing hardware to perform operations comprising:
while a first language pack for use in recognizing speech in a first language is loaded onto the client device, receiving a sequence of input audio frames generated from input audio data characterizing an utterance;
processing, by a language identification (ID) predictor model, each corresponding input audio frame in the sequence of input audio frames to determine a language ID event associated with the corresponding input audio frame that indicates a predicted language for the corresponding input audio frame;
obtaining a sequence of speech recognition events for the sequence of input audio frames, each speech recognition event comprising a respective speech recognition result in the first language determined by the first language pack for a corresponding one of the input audio frames;
based on determining that the language ID events are indicative of the utterance including a language switch from the first language to a second language:
loading, from memory hardware of the client device, a second language pack onto the client device for use in recognizing speech in the second language; and
rewinding the input audio data buffered by an audio buffer to a time of the corresponding input audio frame associated with the language ID event that first indicated the second language as the predicted language;
emitting, using the respective speech recognition results determined by the first language pack for only the corresponding input audio frames associated language ID events that indicate the first language as the predicted language, a first transcription for a first portion of the utterance; and
processing, using the second language pack loaded onto the client device, the rewound buffered audio data to generate a second transcription for a second portion of the utterance.

12. The system of claim 11, wherein:
the first transcription comprises one or more words in the first language; and
the second transcription comprises one or more words in the second language.

13. The system of claim 11, wherein the language ID event determined by the language ID predictor model that indicates the predicted language for each corresponding input audio frame further comprises a probability score indicating a likelihood that the corresponding input audio frame includes the predicted language.

14. The system of claim 13, wherein the operations further comprise:
determining that the probability score of one of the language ID events that indicates the first language as the predicated language satisfies a confidence threshold,
wherein determining that the language ID events are indicative of the utterance including the language switch from the first language to the second language is based on the determination that the probability score of the one of the language ID events that indicates the first language as the predicated language satisfies the confidence threshold.

15. The system of claim 14, wherein the probability score of the language ID event that first indicated the second language as the predicated language fails to satisfy the confidence threshold.

16. The system of claim 14, wherein the corresponding input audio frame associated with the language ID event that first indicated the second language as the predicted language occurs earlier in the sequence of input audio frames than the corresponding input audio frame associated with the one of the language ID events that comprises the probability score satisfying the confidence threshold.

17. The system of claim 11, wherein the operations further comprise:
based on the determination that the language ID events are indicative of the utterance including the language switch from the first language to the second language, setting a rewind audio buffer pin to the time of the corresponding input audio frame associated with the language ID event that first indicated the second language as the predicted language,
wherein rewinding the audio data buffered by the audio buffer comprises causing the audio buffer to rewind the buffered audio data responsive to setting the rewind audio buffer pin to the time of the corresponding input audio frame associated with the language ID event that first indicated the second language as the predicted language.

18. The system of claim 11, wherein each speech recognition event comprising the respective speech recognition result in the first language further comprises an indication that the respective speech recognition result comprises a partial result or a final result.

19. The system of claim 18, wherein the operations further comprise:
determining that the indication for the respective speech recognition result of the speech recognition event for the corresponding input audio frame associated with the last language ID event to indicate the first language as the predicted language comprises a partial result; and
setting a forced emit pin to a time of the corresponding input audio frame associated with the last language ID event to indicate the first language as the predicted language, thereby forcing the emitting of the first transcription of the first portion of the utterance.

20. The system of claim 11, wherein the first language pack and the second language pack each comprise at least one of:
an automated speech recognition (ASR) model;
parameters/configurations of the ASR model;
an external language model;
neural network types;
an acoustic encoder,
components of a speech recognition decoder, or
the language ID predictor model.
